(19) United States
(12) Patent Application Publication
(10) Pub. No.: US 2019/0308579 A1
(43) Pub. Date: Oct. 10, 2019

(54) Seat Sensing and Reporting Apparatus

(71) Applicant: Astronics Advanced Electronic Systems Corp., Kirkland, WA (US)

(72) Inventors: Jeffrey A. Jouper, Newcastle, WA (US); Mark A. Peabody, Redmond, WA (US); Jonathan D. Neal, Bothell, WA (US); Aaron T. Bonner, Bothell, WA (US)

(21) Appl. No.: 16/372,484

(22) Filed: Apr. 2, 2019

Related U.S. Application Data
(60) Provisional application No. 62/654,062, filed on Apr. 6, 2018.

(51) Int. Cl. B60R 21/015; G06K 9/00; G01G 19/12; B64D 11/06

(52) U.S. Cl. CPC B60R 21/0152; G06K 9/00536; B64D 2045/0085; B64D 11/06; B60R 21/01542; G01G 19/12

(57) ABSTRACT

A system that includes a server, a seat control communications unit and a plurality of sensors to monitor passenger comfort and environmental conditions on a transport vehicle, such as an aircraft. The sensors include temperature, distance measuring, strain gauges, air quality, and other sensors to monitor specific locations on a seat to ensure safe occupancy and comfort.

### CROSS-REFERENCE TO RELATED PATENT APPLICATION

This patent application claims a benefit to the Apr. 6, 2018 filing date of U.S. Provisional Patent Application Ser. No. 62/654,062 entitled “Seat Sensing and Reporting Apparatus.” The disclosure of U.S. 62/654,062 is incorporated by reference herein in its entirely.

### BACKGROUND OF DISCLOSURE

There is a need in the industry to monitor and report information from seats on a transportation vehicle, such as an aircraft, ship or train to provide optimal comfort to passenger.

### BRIEF DESCRIPTION

Sensors mounted strategically on the seat to monitor functions, thermal events, structures and the like are used to report data to a collection and display system for real time data to the flight crew. The same data or additional data can be sent to the ground during flight to alert maintenance that on ground maintenance is required when the aircraft lands. The sensors could include distance measurement, vibration, single or multiple thermal sensors, switching sensors, data from actuators, noise sensors, depth sensors, Volatile Organic Compound (VOC) sensors and air quality sensors. Using this data, the system correlates data from multiple sensors and notifies the cabin crew to take appropriate measures to ensure a comfortable experience for passengers aboard the transportation means.

In one embodiment, the system includes a one or more sensors and access points (for wireless data transfer or a physical data link from each seat structure to a server. Each sensor may have a microcontroller or microprocessor or other logic means to communicate with the control and communications unit in the seat and retrieve data from the sensor. The data is then manipulated into a machine code string to be sent to the server through either the physical data link or a wireless link through an access point. Data sent from the seat to the server is in a data stream containing sensor data requested by the server, seat location for correlating the data to a location in the vessel and any other data available to the sensor or microcontroller on the seat as needed to identify the physical location of the unit transmitting the data and the sensor location within the seat.

Thermal data from the seating surface can be used to monitor a passenger's body temperature. This may indicate the relative health of the passenger. This data can also be used to correlate the heat load of a passenger on the air conditioning system within the aircraft. During epidemics, such as the Avian Flu Virus, the temperature sensor could help indicate if a passenger is suffering from flu symptoms and alert the cabin crew or ground authorities if quarantine is required.

Strain gauge or force sensing resistor sensors in the seat can be used to monitor the weight of each passenger to approximate the physical load on the seat structure as well as the total weight of the aircraft. This can help an airline, for example, to properly load an aircraft for best flight performance.

Distance measurement sensors can be used to monitor seat surface movement, leg rest movement, seat arm, seat back tray and seat position as well as rate of movement change for electric actuators in seats. Many actuators have a sensor in the motor giving relative location of movable surfaces based on the number of turns of the motor and screw drive pitch, or linear monitors at the motor assembly. This information is kept local to the seat for the actuator controller to perform control functions but is not a measure of the actual movement of the surface as only the motor is monitored not the surface being moved. The rate of change data can be important as this can gauge the relative movement speed and signal when this is slowing down indicating that the actuator requires servicing to bring it back to full service. This only works if the data is available to the maintenance personnel through the collection of the data by the server.

Vibration sensors can be used to monitor passenger movements in the seat indicating the discomfort of a passenger. A wiggling passenger may require attention to understand the discomfort so that the cabin crew can intervene making the extended trip more pleasurable for the passenger.

The modularity of sensors and utilization of a Seat Control Interface Module, also called a Control and Communications Unit (CCU), enables the system to be installed as original equipment on a seat structure or installed as a retrofit of an existing seat structure. The ability to be an add-on system is particularly attractive to users that would like to add this feature to an existing seat structure as an up-grade.

### BRIEF DESCRIPTION OF DRAWINGS

FIG. 1 is a side view of a passenger seat with a plurality of sensors.

FIG. 2 is a block diagram of an interconnection between a plurality of seat sensors and a control and communications unit.

FIG. 3 is a block diagram of a system including a seating system and CCU in wireless communication with a server and display unit.

FIG. 4 is a block diagram of an alternative system including a seat system and CCU in wired communication with a server.

FIG. 5 is a schematic of seat sensor system having a single wire interface for communication between the CCU and a first sensor in a string.

FIGS. 6A-6C is a schematic for a sensor used for distance measurement.

FIGS. 7A-7C is a schematic for a sensor used for temperature measurement.

FIGS. 8A-8C is a schematic for a sensor for air quality.

FIG. 9A-9B is a schematic showing a wired interconnection between a CCU and multiple sensors.

FIG. 10A-10B is a schematic showing a wireless interconnection between a CCU and multiple sensors.

### DETAILED DESCRIPTION

A seat sensing and reporting apparatus is mounted to a passenger seat on a transport vehicle, such as a bus, train or aircraft. The apparatus is configured to evaluate passenger biometrics, which is a passenger's physical and behavioral characteristics to maximize the comfort and safety of that passenger and other passengers on the transport vehicle.

The seat sensing and reporting apparatus monitors the environment of the seat, motion and control of the seat, environment and comfort of the passenger to improve passenger comfort and schedule preventative maintenance. All movable surfaces such as footrest, arm rest, dividers or food service trays can be monitored for smooth motion, speed of motion and angular position to give feedback to crew members and maintenance personnel on performance of the seat. This information can track the degradation of performance in the seat actuator to schedule maintenance prior to failure of the system leaving passengers in discomfort or feeling as though they did not receive the amenities they paid for.

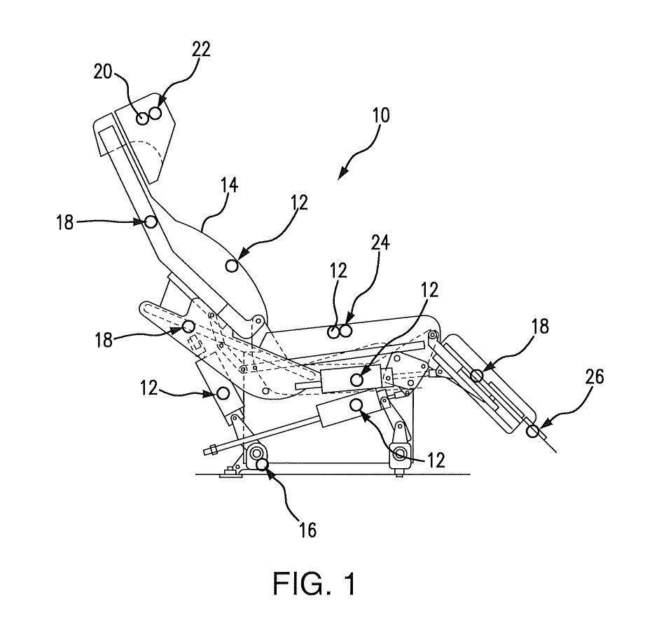

FIG. 1 is a side view of a passenger seat 10 with a plurality of different types of sensors. Not all sensor types are required for each seat configuration. A passenger seat may include all the different types of sensors or any combination of different types of sensors or a single sensor of a representative type.

Thermal sensors 12 monitor the actuator motor temperature and the seat surface 14 temperature at the interface to the passenger and in the back rest of the seat 10 to gain temperature data of the passenger. When a seat is un-occupied, the thermal sensor 12 in the seating surface can monitor the ambient temperature of the cabin as these surfaces will remain at the cabin temperature.

Accelerometer sensor 16 may be used to monitor for vibrations coming from the actuator assemblies monitoring for sticking actuators, failing bearings or obstructions in the movement track of the seat assembly. In addition, the accelerometer sensor 16 can monitor for vibrations consistent with passenger movement caused by discomfort. Vibrations caused by the aircraft structure or turbulence may also be monitored. When monitoring for vibrations of the aircraft, multiple seat sensor systems may reflect the same vibration profile. This data can be used to monitor for reaction of the aircraft to turbulence and the effects on the structure and the passengers. The vibration sensors 16 are located close to a point of interest such as on the actuator for measuring its vibration profile, on the seat pan or back to monitor passenger movement and on the lower leg to monitor the interface of the seat to the aircraft. Placement of the accelerometer sensor 16 is critical to the data being captured but the accelerator sensor design remains largely the same with the exception of mounting features.

Gyroscopic sensor 18 is located on the seat structure and through the use of distance measuring sensors (such as time of flight or IR sensors) monitor for smooth motion and speed of motion when deploying the footrest as an example. A gyroscope sensor on the moving member of the footrest would sense the relative angle of the footrest. This information can be used to monitor the angle of the footrest to ensure it is not deployed during taxi, take-off and landing as required by the Federal Aviation Administration. The information from gyroscopic sensor 18 is communicated to the server through control and communications unit mounted in the seat through either a wired or wireless communication stream.

Acoustical noise sensors 20 are generally located close to the passenger head location to monitor for audible noise that is present around the seat location causing additional discomfort to the passenger. This information can be used to monetize the seating location that has the quietest audible noise signature or offered to premium passengers.

Air quality sensors 22 monitor the Volatile Organic Compounds in the air as well as the equivalent CO₂ (eCO₂). Increasing amounts of VOCs and eCO₂ can come from fuel and fluid vapors, outgassing of materials, exhaust leaking and poor air exchange. Elevated levels of VOCs and of eCO₂ can cause passenger discomfort, such as nausea and drowsiness, and other health risks to passengers and crew. Monitoring the air quality can identify fuel and fluid leaks that happen during flight and can be reported to maintenance crews prior to landing. Air conditioning systems typically control the mixing of fresh and internal heated air to control the eCO₂ build-up. This can also be monitored by these sensors and reported.

Strain gauges or force sensing resistors 24 installed in the seat pan structure can be used to monitor and calculate the presence of a passenger and the passenger's approximate weight. The weight of each passenger is important to an airline for balanced loading and calculating fuel requirements accurately to ensure the minimum amount of fuel required is carried on board without the need to carry excess fuel by over estimating the weight of passengers and materials. This can also be used to ensure that the loading of the seat structure is not exceeded by the weight of the passengers.

Distance measurement sensor 26 monitors seat surface movement, leg rest movement, seat arm, seat back tray and seat position as well as rate of movement change for electric actuators in seats.

A sensor located in the seat belt buckle could be used to monitor if the seat belt is fastened during critical flight phases and during turbulence as indicated by the crew and aircraft signage. As an example, when the fasten seat belt sign is ON, the system could monitor passenger occupation of a seat as well as status of the seat belt for fastened or unfastened to aide in passenger safety and ensure a passenger in a seat has a fastened belt.

The seat belt sensor could be as simple as a closed/open switch to a microcontroller input or more elegantly an energy harvesting switch powered by the movement of the buckle into the latch, sending a code to signify an inserted or removed buckle. These energy harvesting devices exist in the marketplace and can be easily adapted to this application.

As noted, the sensor system can monitor many different phenomenon throughout the passenger area. With sensors imbedded in each seat structure the aircraft can be monitored for additional data such as errant vibrations caused by structural defects, possibly before failure of the structure.

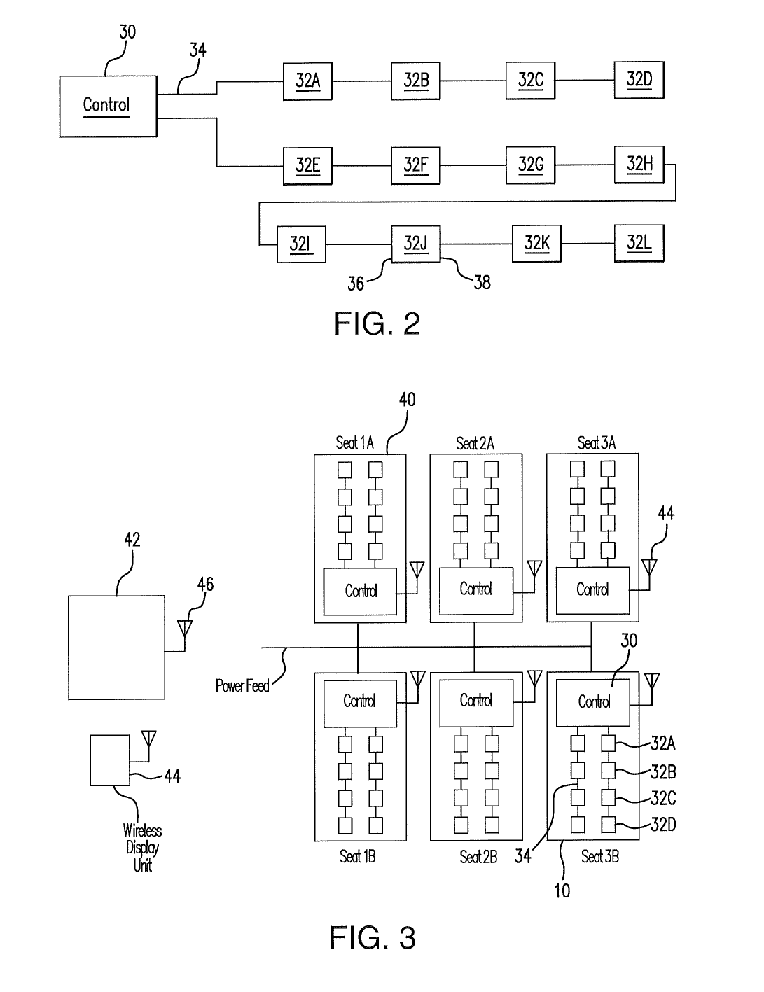

Referring to FIG. 2, the control and communication unit 30 provides a data collection point and operational control of each sensor 32A-32L within the seat area. A communications bus 34 between the control and communication device 30 and each sensor 32A-32L is configured to enable communication between these devices. The CCU 30 performs control of each sensor 32A-32L connected to the communication busses 34 available to the CCU. A single wire communication protocol is depicted in this system to reduce the number of wires between the CCU 30 and each sensor 32A-32L. Each sensor has an input connection 36 and and output connection 38 for power and communications either from the CCU 30 or from the previous sensor in the system. Any combination of sensors on the communications bus 34 is allowable with an arbitrary limit of 32 sensors on a single communication bus 34. The number of sensors allowed is limited by the number of addresses allowable, required data rate to support the number of sensors and the power consumption of each sensor.

Each sensor contains a communication interface, address selection, and at least one sensor to communicate back to the CCU 30 a data value it collects. The CCU 30 selects the address of the appropriate sensor to communicate with and requests the sensor to perform a sensing action over the communications bus 34. The sensor returns the data requested over the same single wire communications bus 34. This is continued for each of the sensors in the seat system at a rate prescribed either by the CCU 32 or the server driving the system. Rates of measurement are selectively set based on the type of sensor and the rate required to adequately monitor the appropriate interface. As an example, temperature sensors change slowly and may require monitoring once per minute while actuator distance measurement may be required several times a second in order to gauge proper movement of a movable surface.

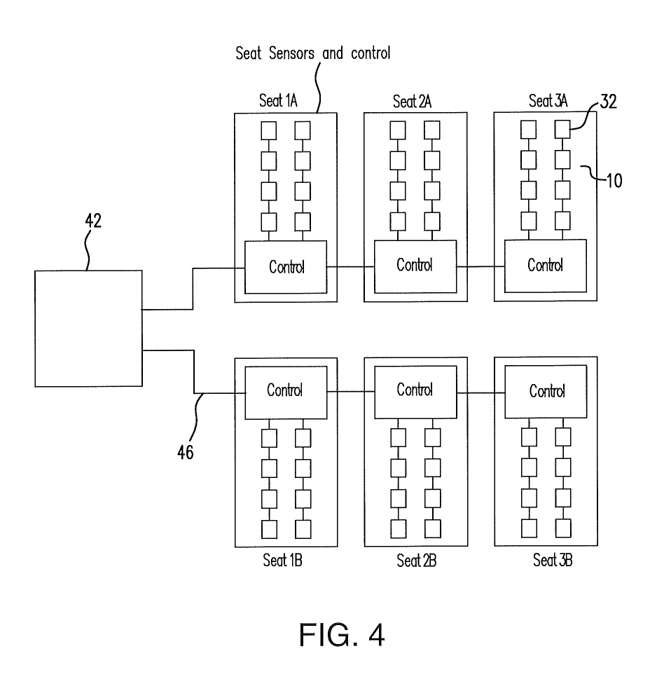

FIG. 3 depicts a wireless communications bus between the seat group 40 and a server 42 through an access points 44, 46. The server is fitted with an interface matching the CCU 30 communications type. Wireless communications could be in the range of 2.4 GHz using a protocol such as WiFi, Zigbee or any appropriate network protocol. The use of a non-proprietary frequency and protocol for world-wide application is preferable. The server 42 may also have wireless access to send data directly to a crew use display unit 44, such as a tablet, to display data such as the position of seats for taxi take-off and landing (TTL). This would give direct feedback to the crew of which seats and passengers to communicate with in order to prepare for TTL. The CCU 30 in the seat group 40 would interact with the sensors in a wired or wireless manner depending on system selection, the number of sensors and the data throughput required to adequately service all of the sensors attached to it. For wireless data to be transferred from the CCU 30 to the server 42, a data rate of 10 megabits per second or higher is preferred to reduce data latency.

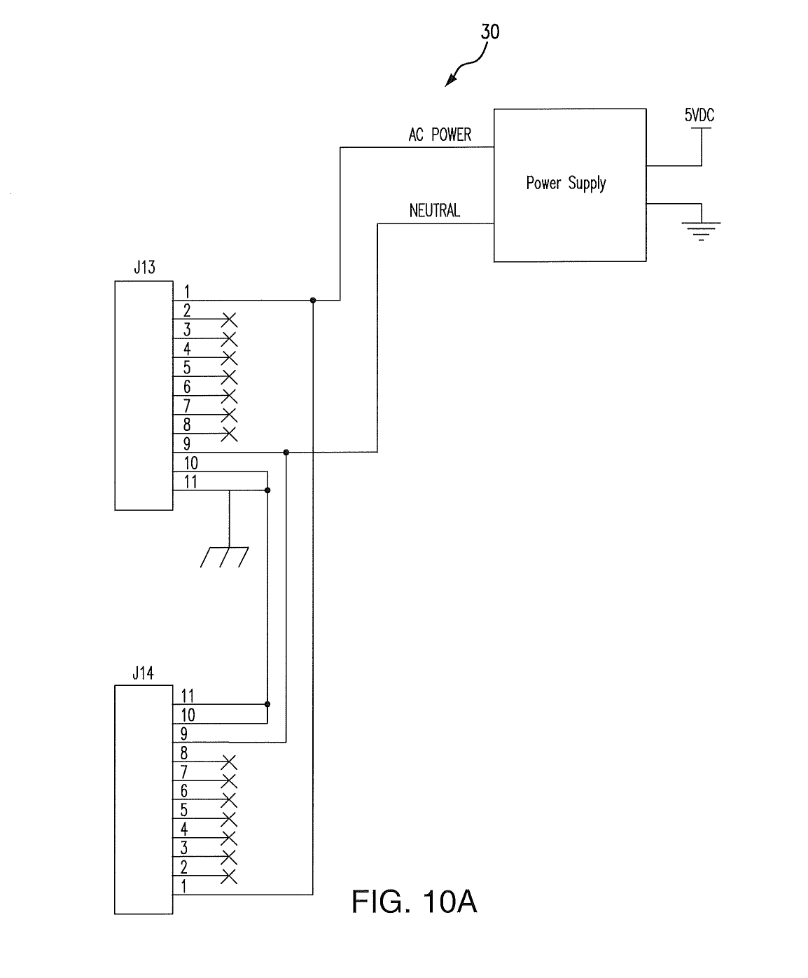

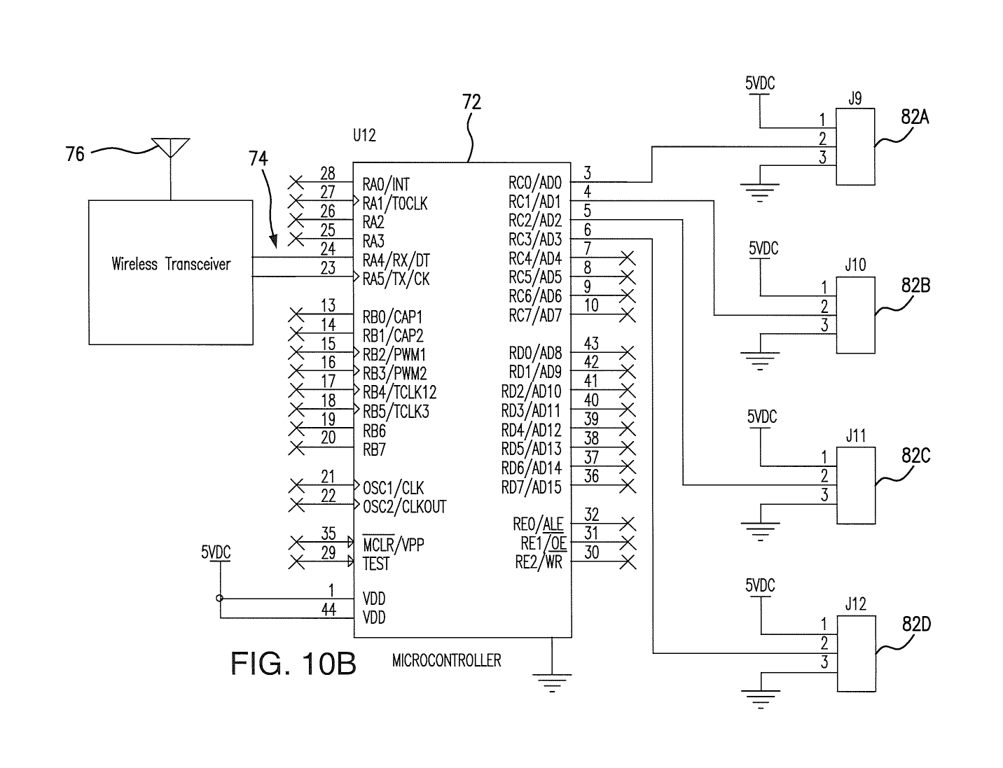

FIGS. 10A-10B is a schematic showing a wireless interconnection between a CCU 30 and multiple sensors. The CCU in this embodiment takes wireless communication input and translates this to single wire interface information to be sent to the downstream sensors within that seat. The wireless communication from the server is coupled through the antenna 76 mounted on the CCU. The microcontroller 72 monitors the serial port 74 of the wireless transceiver for a correct address corresponding to this CCU. If the correct address is seen, the microcontroller will communicate with the server via the wireless interface. The server will initiate a data transfer from the microcontroller in the CCU and extract data stored on the CCU. Once data is extracted and verified with a checksum, the CCU microcontroller will flush its data storage space to be ready to accumulate more data from its sensors.

Each of the four interfaces 82A-82D provide power and a single wire data signal to sensors attached in a serial fashion to the respective connector. The power supply circuit is well known within engineering art and will not be described in this text. The power supply converts local power such as 380-800 Hz power to 5 VDC or other voltages as needed to operate circuits. The wireless interface can be a WiFi, Zigbee, or any relatively high bandwidth wireless communication protocol.

For wired systems, as shown in FIG. 4, Ethernet is a preferred structure from the server 42 to each seat 10. A data rate of 10 megabits per second or higher is preferred. Use of Ethernet allows for easy addressing of sensors 32 and outputs. Power over Ethernet is an option to power each of the sensors 32 over the data lines 46 to eliminate additional wires.

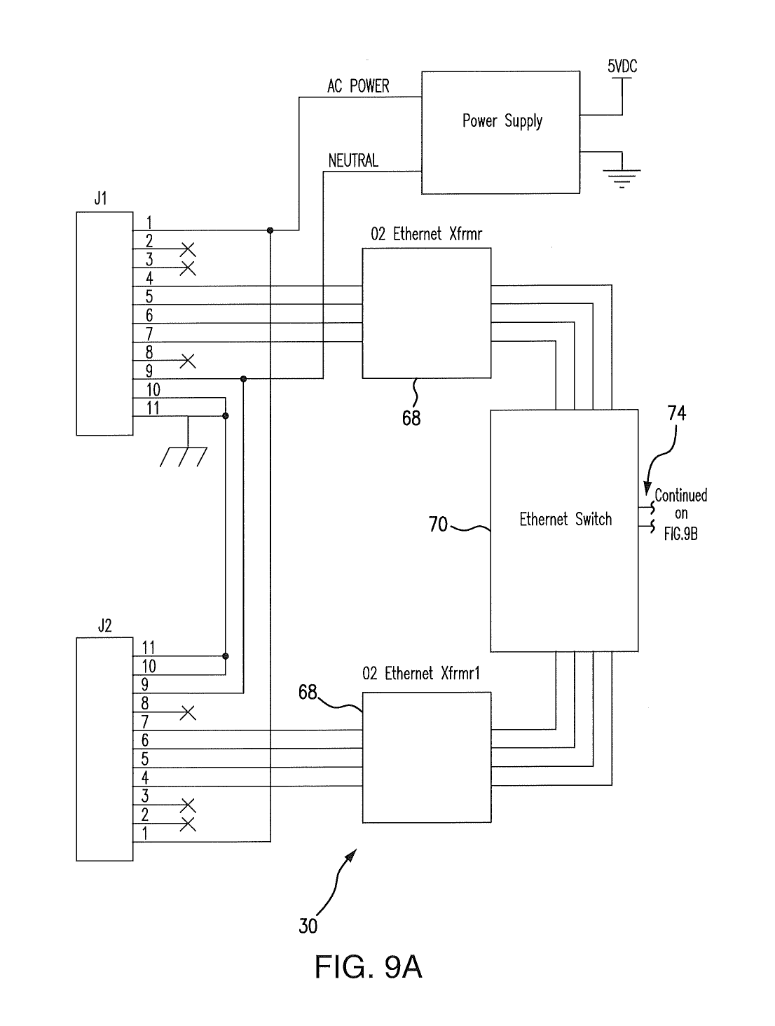

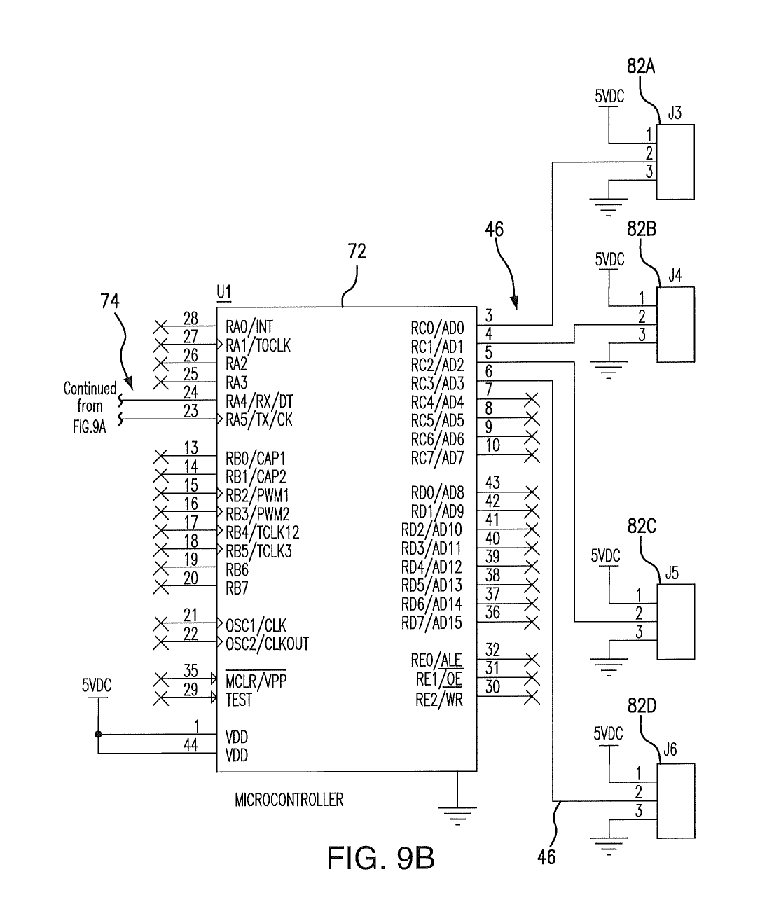

FIG. 9A-9B is a schematic showing a wired interconnection between a CCU 30 and multiple sensors 32A, 32B, 32C, 32D. The CCU in this case takes Ethernet input and translates this to single wire interface information to be sent to the downstream sensors within that seat. The Ethernet from the server is coupled through the Ethernet isolation transformer 68 and sent to the Ethernet switch 70. The microcontroller 72 monitors the Ethernet traffic for an address matching its media access control (MAC) address. If the correct address is seen, the microcontroller 72 will communicate with the server. The server will initiate a data transfer from the microcontroller in the CCU and extract data stored on the CCU. Once data is extracted and verified with a checksum, the CCU microcontroller 72 will flush its data storage space to be ready to accumulate more data from its sensors. If the MAC address is not a match, the data command from the server will propagate to the next Ethernet node and continue on until the correct address is found.

Each of the four interfaces 82A, 82B, 82C, 82D provide power and a single wire data signal 46 to sensors attached in a serial fashion to the respective connector. The power supply circuit is well known within engineering art and will not be described in this text. The power supply converts local power such as 380-800 Hz power to 5 VDC or other voltages as needed to operate circuits. The Ethernet switch is also a well-known circuit consisting of a 2 port switch, and serial port attached to the microcontroller. The microcontroller 52 communicates by single wire interface 46 to the sensors downstream and by serial port 74 upstream to the Ethernet switch 70 and on to the server.

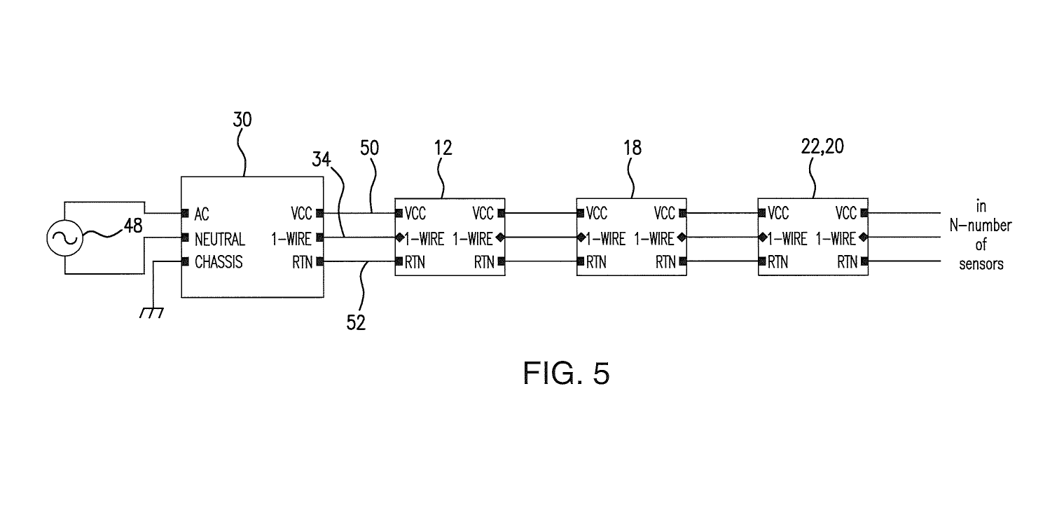

FIG. 5 is a schematic diagram of the in seat network. A power source 48, typically AC aircraft generated power, is converted to direct current, typically 5 VDC, in the CCU 30. The DC voltage is then used to power the sensors 12, 18, 20, 22 via a positive connection for power 50 and a negative connection for power 52.

The CCU 30 communicates through a data bus 34 to the sensors 12, 18, 20, 22 attached to one of the multiple communication busses of the CCU. Two are shown for illustration purposes. Only three interface wires are required between the CCU 30 and the first sensor 12. This is carried through from the first sensor 12 to the second sensor 18 and on. Each sensor will only respond to an addressed message from the CCU 30 to the appropriate sensor with the correct address. Addressing provided allows for up to 32 addresses on each single wire interface. Increased number of address can be accomplished as a design choice. The single wire communications interface will allow communication to one sensor at a time in duplex operation and can also be used to communicate to all sensors at once in a broadcast operation. Address 0 is reserved for the CCU 30 as the master on the communications bus 34 and address 31 (logical) for broadcast communications intended for all sensors. All other addresses are available for sensor addressing. Each sensor is assigned a unique address within the data communications bus attached to the CCU.

An Exemplary Embodiment is a description of the system and communications within the system, points of data storage for short term at the CCU 30 and long term at the server as well as the use of the data. An exemplary embodiment would consist of a server 42, either wired or wireless communication, a CCU 30 for each seat either wired or wireless as matches the server 42 and multiple sensors 12, 18, 20, 22 attached to each CCU 30. Sensors are strategically located to monitor seat surface movements, passenger movement and thermal inputs from the seat structure. Each sensor within the system will perform single or multiple sensing applications. As an example, an acoustical noise sensor 20 may be combined with an air quality sensor 22 and housed in a single sensor unit.

Referring back to FIG. 3, communication from the CCU 30 to a specific sensor 32A would start by polling the sensor address and determining the capability of the sensor and if data is available. This would give the CCU 30 a reference for the data that will be extracted from the sensor. A sensor protocol defined by the type data, data length, unit address and sensor type is communicated from the sensor 32A to the CCU 30. This communication is repeated for all sensors 32B, 32C, 32D on an interface 34 until all sensors are mapped for address and function.

The server 42 then sends a command to the appropriate seat CCU 30 for communication and begins a communication sequence. Once the seat 10 is addressed the CCU 30 collects the data requested by the server 42 and returns the data to the server corresponding to the sensor map of the seat. The server 42 is the collection point for all of the data from each seat sensor system. This allows the server 42 to collect the entire vehicle seating data to be collected and manipulated into messages that can be displayed on a crew terminal for wired applications or a crew tablet 44 for wireless applications. The data can be tracked as instantaneous information such as the position of the footrests or monitored over time in the case of actuator travel speed and smooth motion. The data can be presented in any format usable to either the flight crew or ground maintenance personnel. Data collection is performed identically whether the system is wired or wireless.

The server 42 is a computer or other digital processing device configured to process data, format messages, send command data to the CCU 30 through a fitted interface matching the CCU, store data in a database and send messages to the crew terminal or tablet 46 as appropriate. The data bus structure is as previously described depending on the system architecture choice. The server is generic with the exception of the data communication interface 44, 46 which must match the CCU 30 at the seat 10 as well as the crew terminal or crew tablet 46. Crew terminals are preferably fitted with either an Ethernet interface at a minimum of 10 megabits or an RS-485 interface. The crew terminal is typically existing on the aircraft for other systems to display data and a protocol is already defined for that interface. The server 42 must be able to communicate to the crew terminal in a manner meeting the crew terminal protocol. Wireless crew tablet 44 typically operates in either the 2.4 GHz or 5.0 GHz range meeting WiFi standards of communication. The server 42 operating in a wireless system must containing a transceiver that can cooperatively communicate with the crew tablet.

The CCU 30 is the data collection hub for the seat structure sensors 32. The CCU includes an operable interface matching the server 42 for communications to the server, power conditioning to provide power to the sensors, one or more communication nodes to communicate with sensors attached to that node, a microcontroller to perform communication with the sensors, catalog data and communicate back to the server when commanded. When commanded by the server or at a scheduled reporting rate, the appropriate CCU matching the address will return a message containing all of the data requested by the server. The CCU monitors all of its sensors at an interval matching the sensor type. Depending on the sensor, polling may be from several times per second to once per minute. Data taken from each sensor is stored in a database to allow the information to be sent to the server when requested. The microcontroller contains firmware operative to communicate with each sensor or multi-sensor over the single wire interface, inter integrated circuit or serial peripheral interface bus. Only one sensor is communicated with at a time in transmit and response format. The CCU sets the address select bits to the address of the sensor to communicate with and sends a command to transfer data. The sensor receives the command and sends and acknowledge (ACK) message in return. The CCU then sends a transfer command to the sensor address and the sensor responds by sending a data stream containing pertinent data collected by the sensor. This operation is asynchronous from the operation of the CCU to the server. Transmission across the single wire interface is selected at 1 megabit per second to allow for relatively high data throughput on the bus. Higher data rates can be used if larger numbers of sensors with more complex data are used, lower data rates can be used for small numbers of simple sensors. The data collected by each sensor varies in data length depending on the data packet size held in the sensor until transmission of its data.

Each sensor has a sensing element operative to measure the desired environmental input, a microcontroller containing firmware to operate the sensor interface and a single wire interface to upstream and downstream sensors or the CCU. Addressing of the sensor can take a couple of forms. A binary switch element can program the address at the sensor with a series of 5 open/closed switches or a preferred automatic addressing scheme can be employed. In automatic address operation The CCU would control power to one of the communication interfaces powering all of the sensors on that bus. As the sensors are powered, each opens a switch in the data path to downstream devices. In this mode, the default address for all sensors is address 1. Because communication to all sensors except the one attached to the CCU are disabled by opening relays, only the first sensor will acknowledge a communication from the CCU. The CCU sends an identify command to the sensor at address 1. The sensor responds with sensor type or types. The CCU sets this to a database location corresponding to the first sensor on the bus. A second command is set to change the dynamic address of the sensor to address 2. The CCU then sends a status command to address 2 where the sensor responds with an ACK at address 2. The CCU then commands the sensor at address 2 to close the output switch allowing data to flow to the next sensor. By default, the next sensor is at address 1. The CCU communicates with the second sensor in the same manner collecting the sensor type and assigning the next dynamic address to 3 for the second sensor. This continues through the full range of sensors attached to the CCU communication bus 1. If multiple communication busses are used, each will go through the same sequence until all sensors within the seat group are mapped. Each sensor will collect data from its sensor based on the sensor type and firmware commands for data collection periods, store the data locally for retrieval by the CCU.

The CCU stores all the data collected from each sensors attached to each CCU communication busses. Data is held in non-volatile memory until the server requests a data transfer from the CCU. The server requests data transfer from all of the CCU seat units at a periodic rate such as once per second for each CCU. This would require a high speed data bus to collect the data from up to 100 CCU units in a relatively short period of time of one second. Once the server has the data from all of the CCU units attached in the system either wirelessly or wired interface, data is compiled in the server for display on the crew terminal or crew tablet. Based on the data collected, the server will update messages and graphics at the crew terminal or tablet.

The data collected at the server is parsed into immediate feedback data needing immediate intervention by the crew and data for maintenance personnel when the aircraft lands. Data sent to the crew terminal or tablet may contain, mechanical failure of the seat actuator over temperature, extremely poor air quality, severe vibration or anything directly effecting the passenger comfort or safe travel. Data indicating slow movement of surfaces, intermittent movement, incorrect angle of leg rests, seat backs or tray table can be logged on the maintenance screen to alert ground personnel of issues that need resolving prior to next flight or noted for the next schedule maintenance check.

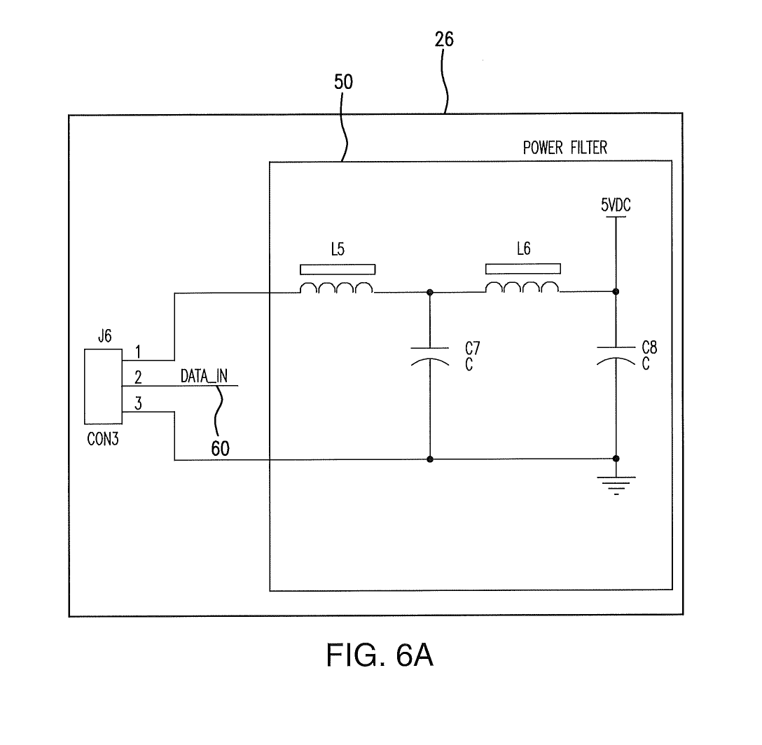

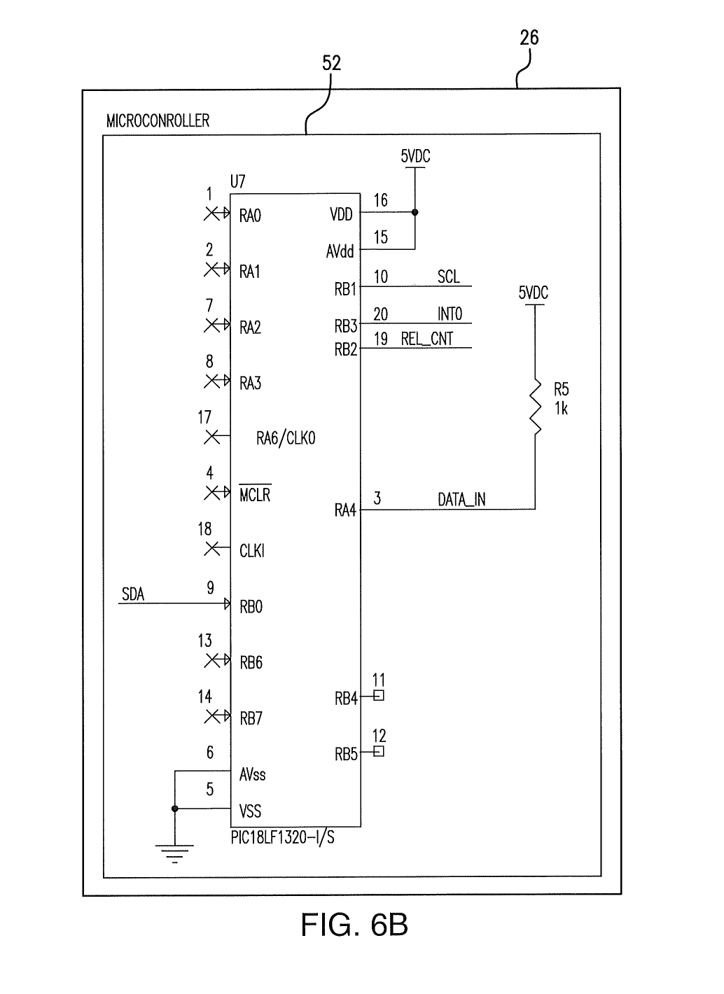

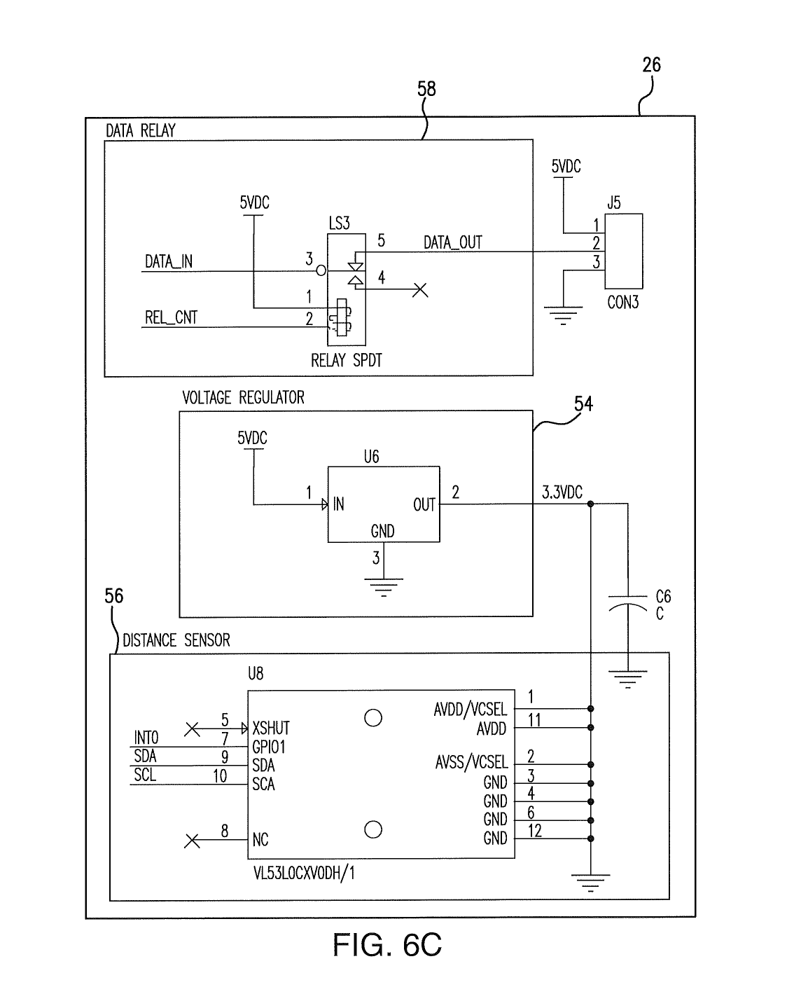

FIGS. 6A-6C is a schematic for a sensor 26 used for distance measurement. The distance measurement sensor contains an input power filter 50, a microcontroller 52, voltage regulator 54, range sensor 56 (for example a laser) and data control relay 58. Power and data are fed into the sensor through input connector 36. The 5 VDC power is filtered for noise through the power filter 50 before being used by the circuits within the sensor. Voltage regulator 54 drop the 5 VDC to 3.3 VDC used by a laser range sensor 56 or other voltage appropriate for another type of range sensor. At initial power up, the microcontroller 52 is held in reset momentarily by an internal reset circuit. This allows for power to be applied and stabilize before the microcontroller begins operation. When the reset period expires the microcontroller 52 sets its address on the bus to 1 and opens data relay 58. The microcontroller then waits for an instruction from the CCU to begin operation by sending an identify command across the DATA_IN signal line 60. The sensor 26 responds with sensor type or types. The CCU sets this to a database location corresponding to the first sensor on the bus. A second command is sent to change the dynamic address of the sensor to address 2 or the appropriate address for the location in the string of sensors. The CCU then sends a status command to address 2 where the sensor 26 responds with an ACK at address 2. The CCU then commands the sensor at address 2 to close the data control relay 58 allowing data to flow to the next sensor. The closed data control relay 58 allows data to pass to the next sensor which is also set to address 1. This sequence repeats until all sensors on the bus are enumerated. Once enumerated, the sensor 26 begins to monitor data at the sensor by communicating with the sensor on a periodic bases and measuring the distance targeted. The typical measurement rate for this sensor is 10 times per second.

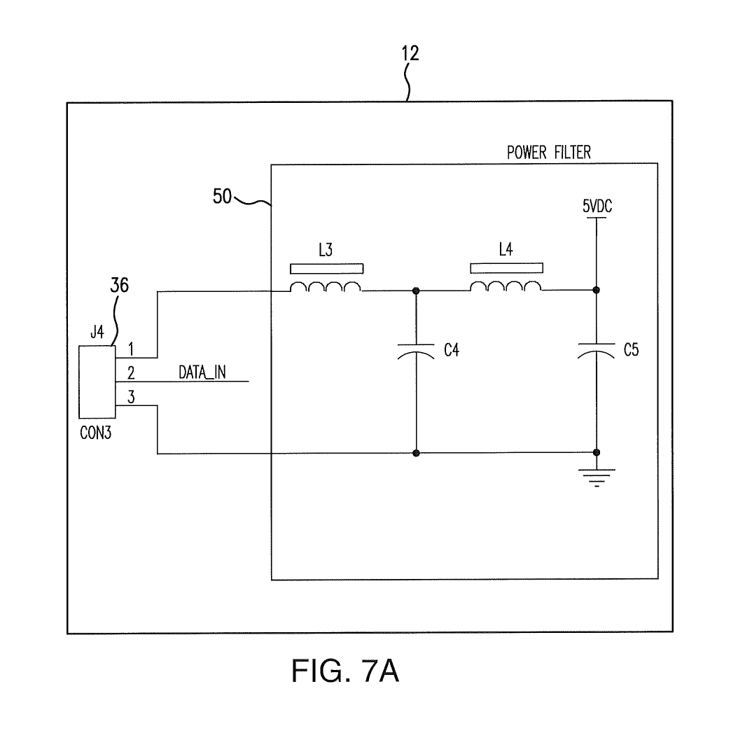

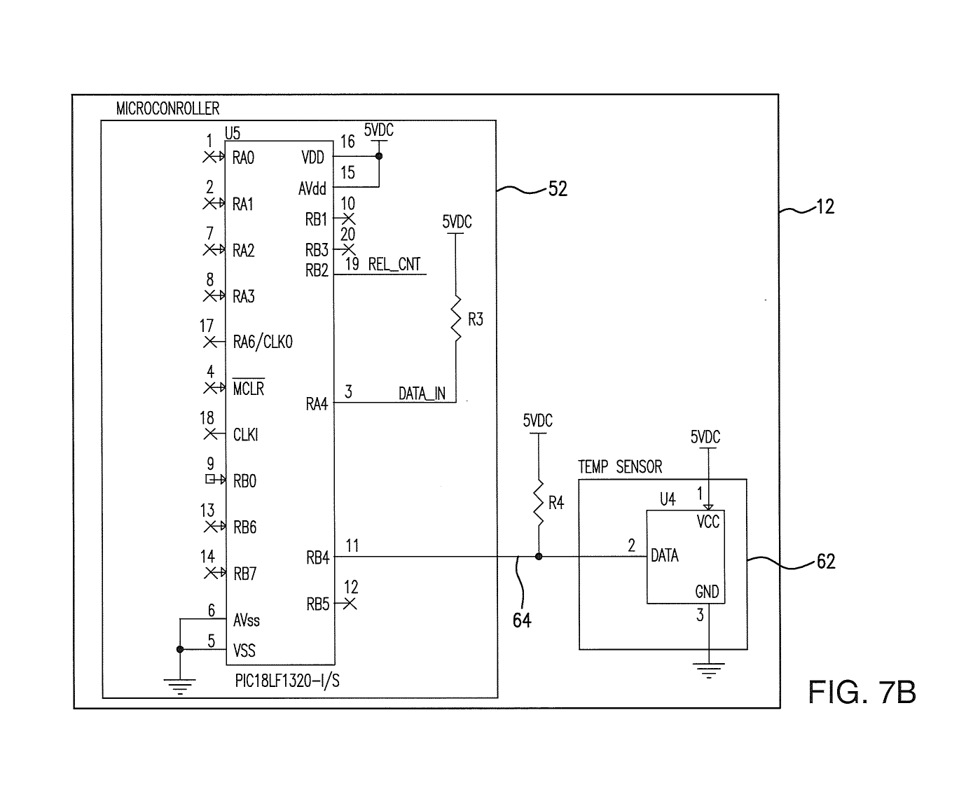

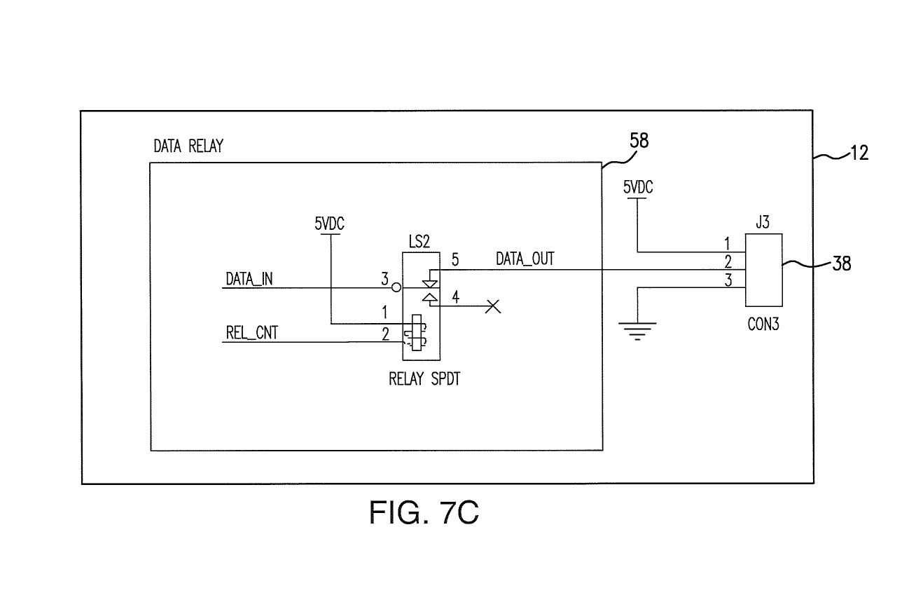

FIGS. 7A-7C is a schematic for a sensor used for temperature measurement. The temperature measurement sensor contains an input power filter 50, a microcontroller 52, temperature monitor 62 and data control relay 58. Power and data are fed into the sensor through input connection 36. The 5 VDC power is filtered for noise through the power filter 50 before being used by the circuits within the sensor. The temperature monitor 62 is preferably an integrated circuit with a single wire interface 64. This is the actual measurement device. At initial power up, the microcontroller 52 is held in reset momentarily by an internal reset circuit. This allows for power to be applied and stabilize before the microcontroller begins operation. When the reset period expires the microcontroller 52 sets its address on the bus to 1 and opens relay 58. The microcontroller then waits for an instruction from the CCU to begin operation by sending an identify command across the DATA_IN signal line. The sensor 12 responds with sensor type or types. The CCU sets this to a database location corresponding to the first sensor on the bus. A second command is sent to change the dynamic address of the sensor to address 2 or the appropriate address for the location in the string of sensors. The CCU then sends a status command to address 2 where the sensor responds with an ACK at address 2. The CCU then commands the sensor at address 2 to close the data control relay 58 allowing data to flow to the next sensor by way of the output connector 38. The closed data control relay 58 allows data to pass to the next sensor which is also set to address 1. This sequence repeats until all sensors on the bus are enumerated. Once enumerated, the sensor begins to monitor data at the sensor by communicating with the sensor on a periodic bases and measuring the temperature targeted. The typical measurement rate for this sensor is once per minute.

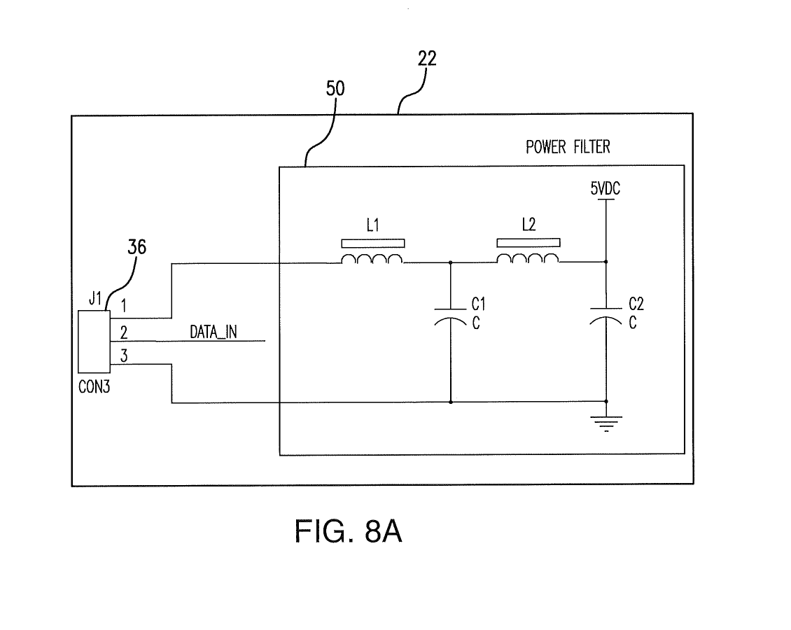

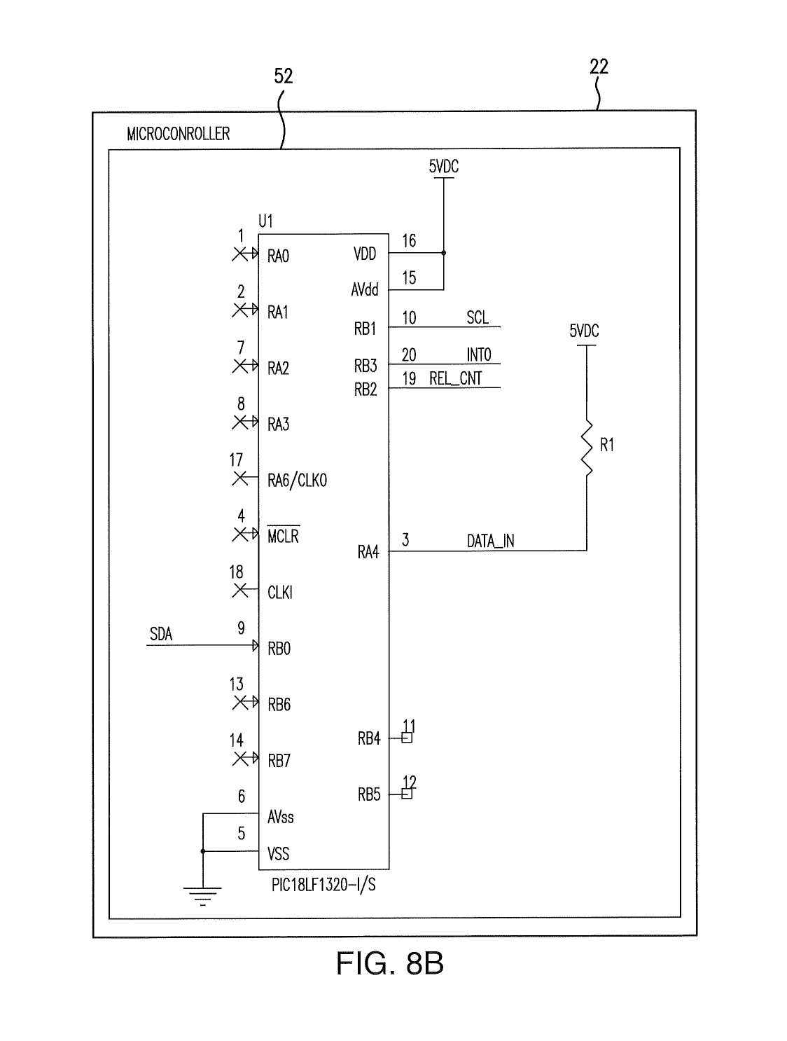

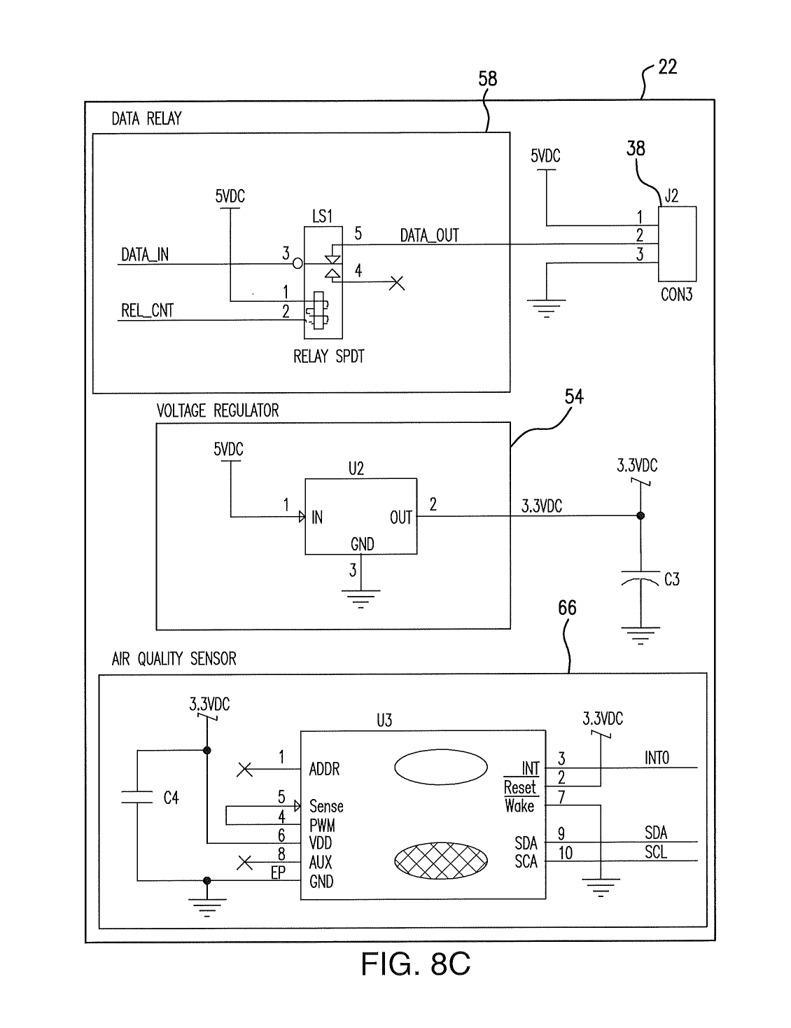

FIGS. 8A-8C is a schematic for a sensor for air quality. The air quality measurement sensor 22 contains an input power filter 50, a microcontroller 52, volatile organic compound (VOC) monitor 66 and data control relay 58. Power and data are fed into the sensor through input connector 36. The 5 VDC power is filtered for noise through the input power filter 50 before being used by the circuits within the sensor. Voltage regulator 54 drops the 5 VDC to 3.3 VDC, or other voltage, used by the VOC monitor 66. The VOC monitor 66 is preferably and integrated circuit an I2C (inter-integrated circuit) communications interface to the microcontroller 52. The VOC monitor 66 is the actual measurement device. At initial power up, the microcontroller 52 is held in reset momentarily by an internal reset circuit. This allows for power to be applied and stabilize before the microcontroller begins operation. When the reset period expires the microcontroller sets its address on the bus to 1 and opens data control relay 58. The microcontroller 52 then waits for an instruction from the CCU to begin operation by sending an identify command across the DATA_IN signal line. The sensor responds with sensor type or types. The CCU sets this to a database location corresponding to the first sensor on the bus. A second command is sent to change the dynamic address of the sensor to address 2 or the appropriate address for the location in the string of sensors. The CCU then sends a status command to address 2 where the sensor responds with an ACK at address 2. The CCU then commands the sensor at address 2 to close the data control relay 58 allowing data to flow through the output connector 38 to the next sensor. The closed data control relay 58 allows data to pass to the next sensor which is also set to address 1. This sequence repeats until all sensors on the bus are enumerated. Once enumerated, the sensor begins to monitor data at the sensor by communicating with the sensor on a periodic basis and measuring the air quality. The typical measurement rate for this sensor is once per minute.

What we claim is:

1. A system to monitor and report passenger biometrics on a transport vehicle, comprising:
a passenger seat having a plurality of sensors mounted thereon;
a first communication link between the plurality of sensors and a server; and
a second communications link between the server and a display.

2. The system of claim 1 wherein a control and communications unit is connected to the first communication link and disposed between the plurality of sensors and the server.

3. The system of claim 2 wherein the first communication link supports two-way communication.

4. The system of claim 3 wherein one or more thermal sensors are configured to monitor one of more of a seat actuator motor temperature, seat surface temperature at interface with the passenger and ambient temperature of a cabin of the transport vehicle.

5. The system of claim 3 wherein one or more accelerometer sensors are configured to monitor vibrations consistent with one or more of a mechanical issue, passenger discomfort, structural issues and turbulence.

6. The system of claim 5 wherein data from multiple passenger seats is aggregated to monitor structural issues and turbulence.

7. The system of claim 3 wherein one or more gyroscopic sensors are configured to monitor a moving member.

8. The system of claim 7 wherein the moving member is a footrest associated with the passenger seat.

9. The system of claim 3 wherein one or more acoustical noise sensors are configured to monitor a noise level adjacent the passenger.

10. The system of claim 3 wherein one or more air quality sensors are configured to monitor one or more of volatile organic compounds and equivalent carbon dioxide.

11. The system of claim 3 wherein one or more strain gauges are configured to monitor the presence of a passenger in in a seat and a weight of that passenger.

12. The system of claim 11 wherein a passenger weight is associated with that passenger's seat to facilitate balanced load and calculate fuel requirements.

13. The system of claim 3 wherein one or more distance measurement sensors are configured to monitor seat surface movement.

14. The system of claim 13 wherein monitoring seat surface movement includes monitoring movement change for electric actuators.

15. The system of claim 3 wherein a communications bus interconnects the control and communications device with the plurality of sensors.

16. The system of claim 15 wherein the interconnection is by a single wire communication protocol.

17. The system of claim 15 wherein the control and communications device is configured to regulate a rate of sensing for each type of sensor.

18. The system of claim 15 wherein the control and communications device includes a power converter effective to convert incoming alternating current to direct current.

19. The system of claim 18 wherein the incoming alternating current is at a frequency of between 380 Hz and 800 Hz and the output is 5 volts DC.

20. A method for measuring and reporting passenger biometrics on a transport vehicle comprising:
a. communicating passenger data from a plurality of sensors to a control and communications device, said control and communications device configured to address each sensor and each passenger seat to maintain passenger data identification; and
b. transmitting the passenger data to a server configured to determine data relevance and transmit relevant data to a display.

21. The method of claim 20 wherein the transport vehicle is an aircraft and the server selectively sends passenger data to either a ground crew or a cabin crew.

22. The method of claim 21 wherein the control and communications device converts incoming aircraft alternating current to direct current of a voltage useable by said plurality of sensors.

23. The method of claim 22 wherein a microprocessor located within the control and communications device polls each type of sensor for information at a different time interval, dependent on sensor type.

24. The method of claim 23 including selecting sensors from the group consisting of thermal sensors, accelerometer sensors, gyroscopic sensors acoustical noise sensors, air quality sensors, strain gauges and distance measurement sensors.
